(19) United States
(12) Patent Application Publication
(10) Pub. No.: US 2011/0194298 A1
(43) Pub. Date: Aug. 11, 2011

(54) LASER ADJUSTMENT APPARATUS

(76) Inventor: Wen-Sen LIN, Taichung City (TW)

(21) Appl. No.: 12/703,791

(22) Filed: Feb. 11, 2010

(51) Int. Cl. F21S 8/00

(52) U.S. Cl. 362/421

(57) ABSTRACT

A laser adjustment apparatus includes a housing. A first cutout which has a through hole defined therein is formed in the housing. The first cutout is semi-spherical. Two screw holes are respectively defined in two sides of the housing. A holder is received in the housing. The holder has a second cutout formed therein and engaged with the first cutout. The second cutout has a semi-spherical shape. A laser module includes a light emitting portion and a tubular body connected thereto. The light emitting portion is received in the first and the second cutouts. A first and a second adjusting units are respectively passing through the two screw holes in the housing. The first and the second adjusting unit respectively perpendicularly abut against the tubular body of the laser module. A projecting angle of the laser module is adjusted by adjusting the first and the second adjusting unit.

### BACKGROUND OF THE INVENTION

1. Field of the Invention

The present invention relates to a laser apparatus, and more particularly, to a laser adjustment apparatus for providing an adjustable projection line.

2. Description of Related Art

Laser light is spatially coherent, and is a narrow low-divergence beam. The coherency of laser light allows the laser light to be projected on a relatively distant focal point easily. Therefore, laser light devices or apparatus have been widely applied in various fields, especially in the home construction and general construction industries which often require positioning a reference spot or displaying a level line on a surface. Various laser adjustment devices for adjusting the projection line of the laser have been innovated due to the market's demand.

A conventional laser adjustment device includes a laser light source, a pendulum connected to the reflector and a mounting frame supporting said laser light source and said pendulum by independent gimbal suspension whereby said laser light source moves responsive to pendulum motion through one-half the rotational angle of said pendulum, correcting an optical path in accordance with changes in the position of the pendulum relative to the mounting frame.

However, the conventional laser adjustment device has the following drawbacks:

First of all, the conventional laser adjustment device is bulky in size, and therefore is not convenient to carry around; secondly, the conventional laser adjustment device consists of many components, it is time-consuming to assemble all the components together, thereby the cost for manufacture is increased. In addition, with so many components, once a component is broken, it is difficult and complicate to replace the component.

Therefore, it can be concluded above that the conventional laser adjustment device is high in cost for manufacture, and is difficult to maintain with its complicated structure.

The present invention has arisen to obviate/mitigate the disadvantages of the conventional laser adjustment device.

### SUMMARY OF THE INVENTION

The main objective of the present invention is to provide an improved laser adjustment apparatus.

To achieve the objective, the laser adjustment apparatus in accordance with the present invention comprises a housing. A first cutout is formed in an inner surface of the housing. The first cutout has a semi-spherical shape. The housing has a through hole defined in a center of the first cutout and extending therethrough. Two screw holes are respectively defined in two sides of the housing. A holder is mountably received in the housing. The holder has a second cutout formed therein and engaged with the first cutout which is formed in the inner surface of the housing. The second cutout has a semi-spherical shape corresponding to that of the first cutout of the housing such that the first cutout and the second cutout configured a spherical shape.

A laser module includes a spherical light emitting portion and a tubular body which is connected to the light emitting portion. The light emitting portion has an annular ring disposed on an outer periphery thereof. A spherical annular sleeve is sleeved on the outer periphery of the light emitting portion and is embeddedly engaged with the annular ring such that the annular sleeve is securedly sleeved on the outer periphery of the light emitting portion of the laser module. The light emitting portion is fittedly rotatably received in the first cutout and the second cutout. A first adjusting unit and a second adjusting unit respectively screwedly pass through the two screw holes in the housing. A distal end of the first adjusting unit perpendicularly abuts against the tubular body of the laser module. A distal end of the second adjusting unit perpendicularly abuts against the tubular body of the laser module. The first adjusting unit and the second adjusting unit are perpendicularly located relative to each other.

A resilient unit is disposed in the housing. Two ends of the resilient unit respectively elastically abut against the tubular body of the laser module and the housing such that the tubular body of the laser module is tightly and continuously abutted by the first adjusting unit and the second adjusting unit through adjustment. A positioning unit passes through the resilient unit and is screwed to the holder which is mounted in the housing for securingly positioning the resilient unit in the housing.

When the tubular body of the laser module is exerted by the first adjusting unit, the tubular body of the laser module is tilted in a vertical manner; and when the tubular body of the laser module is exerted by the second adjusting unit, the tubular body of the laser module is tilted in a horizontal manner. A projecting angle of the laser module is adjusted by adjusting the first adjusting unit and the second adjusting unit.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an assembled perspective rear view of a laser adjustment apparatus in accordance with the present invention;

FIG. 2 is an assembled perspective front view of the laser adjustment apparatus in accordance with the present invention;

FIG. 3 is an exploded perspective view of the laser adjustment apparatus in accordance with the present invention;

FIG. 3A is a cross-sectional view of segment A-A in FIG. 3 of the laser adjustment apparatus in accordance with the present invention;

FIG. 3B is a partially enlarged and partially sectional view of a laser module of the laser adjustment apparatus in accordance with the present invention;

FIG. 4 is a cross-sectional side view of the laser adjustment apparatus in accordance with the present invention;

FIG. 5 is a cross-sectional rear view of the laser adjustment apparatus in accordance with the present invention; and

FIGS. 6-7 are cross-sectional views of the laser adjustment apparatus in accordance with the present invention in operating state.

### DETAILED DESCRIPTION OF THE INVENTION

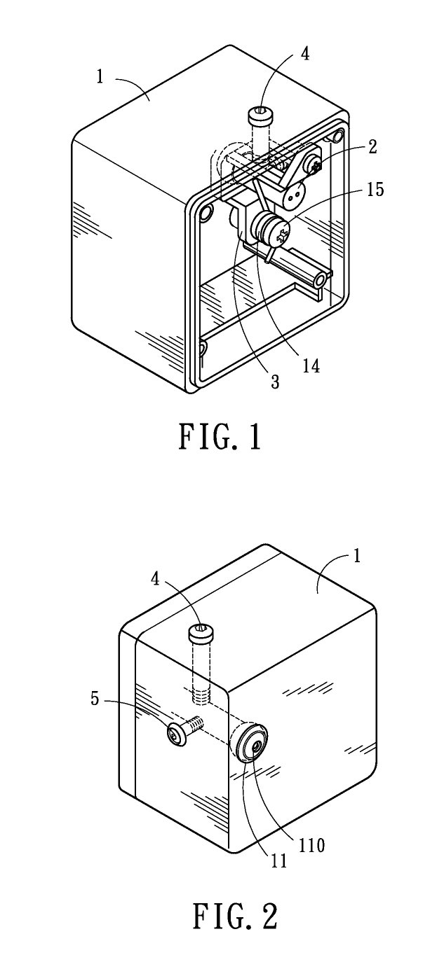

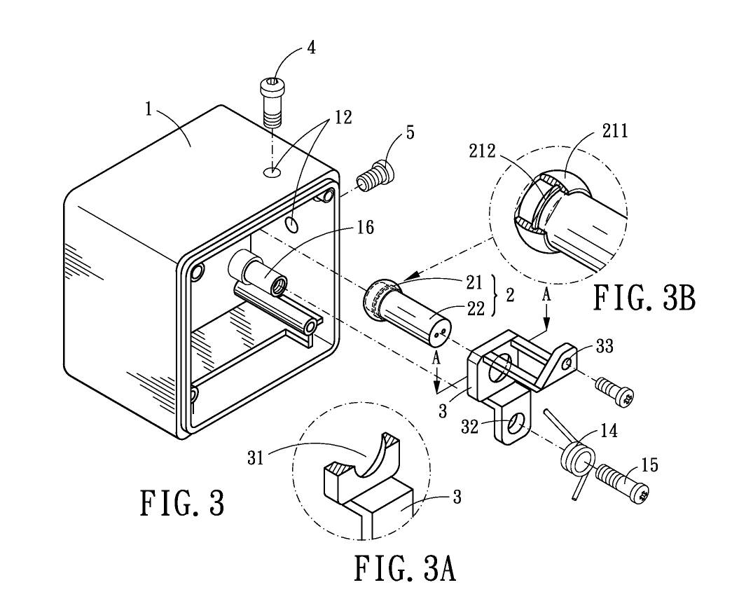

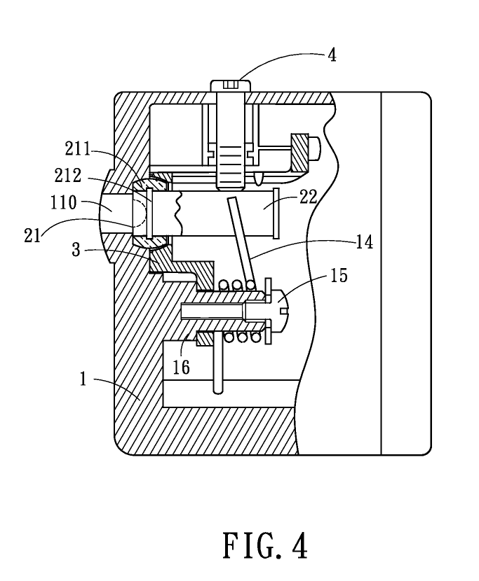

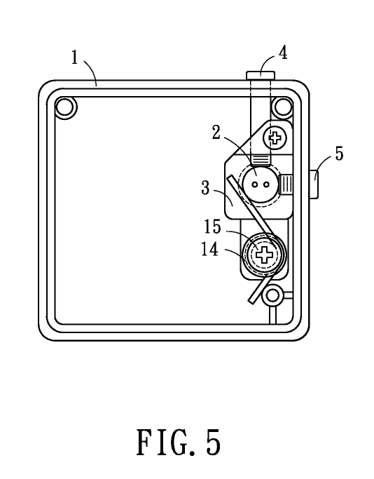

Referring to the drawings and initially to FIGS. 1-5, a laser adjustment apparatus in accordance with the present invention comprises a housing 1. In the present embodiment, the housing 1 has a cubical shape. A first cutout 11 is formed in an inner surface of the housing 1. The first cutout 11 has a semi-spherical shape. The housing has a through hole 110 defined in a center of the first cutout 11 and extending therethrough. Two screw holes 12 are respectively defined in two adjacent sides of the housing 1. The housing 1 has a positioning base 16 disposed therein. The positioning base 16 is located below the first cutout 11 (as shown in FIGS. 1 and 4). A holder 3 is mountably received in the housing 1. The holder 3 has a securing portion 33 disposed thereon for securing the holder 3 with the housing 1. The holder 3 further has a second cutout 31 formed therein and engaged with the first cutout 11 which is formed in the inner surface of the housing 1. The second cutout 31 has a semi-spherical shape which corresponds to that of the first cutout 11 of the housing 1 such that the first cutout 11 and the second cutout 31 configure a spherical shape. A positioning hole 32 is defined in the holder 3. The positioning hole 32 is located below the second cutout 31 and corresponds to the positioning base 16 disposed in the housing 1, such that the holder 3 sleevingly passes through the positioning base 16 via the positioning hole 32 and is positioned in the housing 1.

A laser module 2 includes a spherical light emitting portion 21 and a tubular body 22 which is connected to the light emitting portion 21. The light emitting portion 21 has an annular ring 212 disposed on an outer periphery thereof. A spherical annular sleeve 211 is sleeved on the outer periphery of the light emitting portion 21 and is embeddedly engaged with the annular ring 212 such that the annular sleeve 211 is securedly sleeved on the outer periphery of the light emitting portion 21 of the laser module 2. The spherical light emitting portion 21 has a shape corresponds to that of the spherical shape configured by the first cutout 11 and the second cutout 31 such that the light emitting portion 21 is rotatably received in the first cutout 11 and the second cutout 31. A laser beam emitted by the light emitting portion 21 of the laser module 2 projects through the through hole 110 of the first cutout 11. A first adjusting unit 4 and a second adjusting unit 5 respectively screwedly pass through the two screw holes 12 in the housing 1. As shown in FIGS. 2 and 4-5, a distal end of the first adjusting unit 4 vertically abuts against the tubular body 22 of the laser module 2. A distal end of the second adjusting unit 5 horizontally abuts against the tubular body 22 of the laser module 2. The first adjusting unit 4 and the second adjusting unit 5 are perpendicularly located relative to each other.

A resilient unit 14 is disposed in the housing 1. In the present embodiment, the resilient unit 14 is a torsional spring. Two ends of the resilient unit 14 respectively elastically abut against the tubular body 22 of the laser module 2 and the housing 1. A positioning unit 15 passes through the resilient unit 14 and the positioning hole 32 of holder 3, such that the resilient unit 14 is securedly positioned on the positioning hole 32 of the holder 3 by the positioning unit 15 for refraining the resilient unit 14 from displacing such that the resilient unit 14 is able to continuously abut against the tubular body 22 of the laser module 2. The tubular body 22 of the laser module 2 is tightly and continuously abutted by the first adjusting unit 4 and the second adjusting unit 5 through adjustment due to a resilient force of the resilient unit 14.

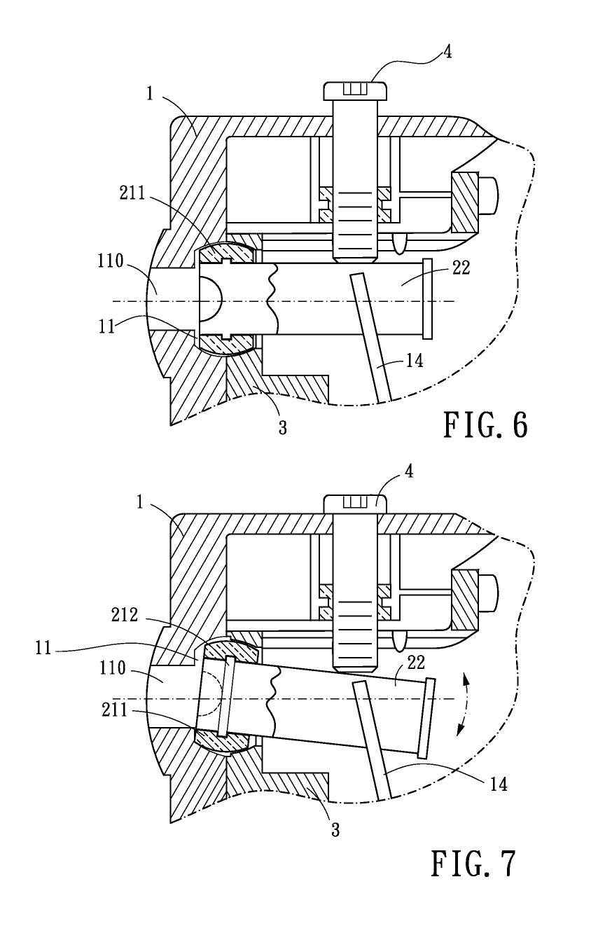

Further referring to FIGS. 6-7, wherein the operation of the laser adjustment apparatus in accordance with the present invention will be described in details below. When the tubular body 22 of the laser module 2 is exerted by the first adjusting unit 4, the tubular body 22 of the laser module 2 is tilted in a vertical manner (as shown in FIG. 7), a projecting angle of the laser module 2 is adjusted vertically; and when the tubular body 22 of the laser module 2 is exerted by the second adjusting unit 5, the tubular body 22 of the laser module 2 is tilted in a horizontal manner. The projecting angle of the laser module 2 is adjusted horizontally. When the first adjusting unit 4 and the second adjusting unit 5 exert on the tubular body 22 of the laser module 2, the tubular body 22 tilts and drives the light emitting portion 21 of the laser module 2 to rotatably shifted in the first cutout 11 and the second cutout 31. Therefore, the projecting angle of the laser module 2 is adjusted by adjusting the first adjusting unit 4 and the second adjusting unit 5. A user may simultaneously adjust the first adjusting unit 4 and the second adjusting 5 to obtain a desired projecting angle of the laser module 2.

Although the invention has been explained in relations to its preferred embodiment, it is to be understood that many other possible modifications and variations can be made without departing from the spirit and scope of the invention as hereinafter claimed.

What is claimed is:

1. A laser adjustment apparatus comprising:
a housing, a first cutout formed in an inner surface of the housing, the first cutout having a semi-spherical shape, the housing having a through hole defined in a center of the first cutout and extending therethrough; two screw holes respectively defined in two sides of the housing;
a holder mountably received in the housing, the holder having a second cutout formed therein and engaged with the first cutout formed in the inner surface of the housing, the second cutout having a semi-spherical shape corresponding to that of the first cutout of the housing such that the first cutout and the second cutout configured a spherical shape;
a laser module including a spherical light emitting portion and a tubular body connected to the light emitting portion; the light emitting portion rotatably received in the first cutout and the second cutout; and
a first adjusting unit and a second adjusting unit respectively screwedly passing through the two screw holes in the housing; a distal end of the first adjusting unit perpendicularly abutting against the tubular body of the laser module; a distal end of the second adjusting unit perpendicularly abutting against the tubular body of the laser module; the first adjusting unit and the second adjusting unit being perpendicularly located relative to each other;
wherein when the tubular body of the laser module is exerted by the first adjusting unit, the tubular body of the laser module is tilted in a vertical manner; and when the tubular body of the laser module is exerted by the second adjusting unit, the tubular body of the laser module is tilted in a horizontal manner; a projecting angle of the laser module is adjusted by adjusting the first adjusting unit and the second adjusting unit.

2. The laser adjustment apparatus as claimed in claim 1 further comprising a resilient unit disposed in the housing; two ends of the resilient unit respectively elastically abutting against the tubular body of the laser module and the housing such that the tubular body of the laser module is tightly and continuously abutted by the first adjusting unit and the second adjusting unit through adjustment due to a resilient force of the resilient unit.

3. The laser adjustment apparatus as claimed in claim 2 further comprising a positioning unit passing through the resilient unit and screwed to the holder mounted in the housing for securingly positioning the resilient unit in the housing.

4. The laser adjusting apparatus as claimed in claim 1, wherein the light emitting portion of the laser module has an annular ring disposed on an outer periphery thereof; a spherical annular sleeve sleeving on the outer periphery of the light emitting portion and embeddedly engaged with the annular ring such that the annular sleeve is securedly sleeved on the outer periphery of the light emitting portion of the laser module.
